(19) United States
(12) Patent Application Publication
(10) Pub. No.: US 2011/0090346 A1
(43) Pub. Date: Apr. 21, 2011

(54) REMOTE VIDEO DEVICE MONITORING

(75) Inventors: Hung John Pham, Cedar Park, TX (US); Bach N. Hoang, Austin, TX (US)

(73) Assignee: AT&T INTELLECTUAL PROPERTY I, L.P., Reno, NV (US)

(21) Appl. No.: 12/580,856

(22) Filed: Oct. 16, 2009

(51) Int. Cl. H04N 17/00

(52) U.S. Cl. 348/180; 348/E17.001

(57) ABSTRACT

Remote video devices are monitored by receiving video pattern data from the remote video devices and comparing device video patterns represented by the video pattern data to predetermined video patterns. If device video patterns match the predetermined video patterns, a rule corresponding to the predetermined video pattern is accessed and execution of a recovery action is initiated.

### BACKGROUND

1. Field of the Disclosure

The present disclosure relates to monitoring remote video devices.

2. Description of the Related Art

Users receive multimedia content (e.g., television programs) over multimedia content distribution networks (MCDNs). The multimedia content is processed at the user's remote location by a remote video device such as a set-top box (STB). An MCDN administrator may be unable to verify and troubleshoot output provided by a remote video device without visiting the site of the remote video device.

### BRIEF DESCRIPTION OF THE DRAWINGS

FIG. 1 depicts a system for remote video device monitoring;

FIG. 2 depicts video images received from a remote video device and predetermined video patterns that are compared against the received video images;

FIG. 3 depicts elements of methods or systems for monitoring remote video devices;

FIG. 4 depicts further elements of methods or systems for monitoring remote video devices; and

FIG. 5 depicts still further elements of methods or systems for monitoring remote video devices.

### DESCRIPTION OF THE EXEMPLARY EMBODIMENTS

Disclosed embodiments relate to monitoring and troubleshooting remote video devices. A particular embodiment relates to a method of monitoring a remote device and includes receiving video pattern data from the remote video device and comparing a device video pattern represented by the video pattern data to a predetermined video pattern. Comparison of the device video pattern to a predetermined video pattern may occur locally at the remote video device or may occur at a location remote to the remote video device. If the device video pattern matches a predetermined video pattern (e.g., a crash screen), the method includes accessing a rule corresponding to the predetermined video pattern. The accessed rule provides information (e.g., steps, preferences, addresses, administrator identification information) and the like for a recovery action, and the method includes executing the recovery action. The recovery action may include contacting an administrator by e-mail, text message, page, telephone call, and the like. If the device video pattern matches a predetermined video pattern for a crash screen, the recovery action may include obtaining a crash log related to the crash screen or a crash event.

In some embodiments, the method is adaptive and includes updating a database of predetermined video patterns based on device video patterns received from remote video devices. The method may include encoding video images received at the remote video device for transmission from the remote device to a pattern detection server at a network operations center (NOC).

Another embodiment relates to a video pattern detection server that includes a processor and electronic storage. The electronic storage includes computer instructions for receiving video data forwarded from a remote location. During normal operation of a video device (e.g., STB) at the remote location, the received video data includes portions of a multimedia program. The received video data includes a remote video pattern that is compared by further computer instructions to stored video patterns to detect a video pattern event. The video pattern event indicates an absence of normal operation of the remote video device. For example, the video pattern event may indicate the presentation of a crash screen by the remote video device.

Further instructions extract a rule from a rule-based video detection database that corresponds to the video pattern event. The rule-based video detection database may include decision tree information. Based on the extracted rule, further instructions initiate a recovery action corresponding to the extracted rule. The recovery action database may include information indicative of automatic recovery procedures for bringing a remote video device to a predetermined state. For example, the predetermined state may be an initial state achieved after a boot up. The predetermined state may also include, as an example, presenting a user with an interface for recording multimedia content received at the remote location.

In some embodiments, the video pattern detection server receives a video stream including video data from a remote video device that is enabled for encoding and streaming the video data. For example, a remote video device may be an STB that is enabled for encoding and streaming to an MCDN device (e.g., the video pattern detection server) each image or selected images that are displayed by the remote video device. In some embodiments, the video pattern detection server is enabled for re-creating a trigger event associated with the remote video pattern. For example, the video pattern detection server may initiate resending multimedia content or other data recently processed by the remote video device to attempt to re-create or repeat the trigger event. The video pattern detection server may also include instructions for contacting an administrator regarding a trigger event. In alternative embodiments, the functionality of the video pattern detection server may be implemented locally at the video device at the remote location. Implementation of the functionality of the video pattern detection server at the remote video device may be within the remote video device itself or may be in a pattern detection device communicatively coupled to the remote video device. Video streams directed to the remote video device may be acquired by the pattern detection device directly, including through baseband video capture or video decoding of the video stream from the remote video device. Such implementation at the remote video device may be beneficial in environments that have highly-congested data traffic and/or low-bandwidth transport media.

Other embodiments relate to a service for detecting video patterns. The service includes streaming encoded video information to a video pattern detection engine or video pattern detection server. The service includes comparing a portion of the video information to stored video patterns and detecting a trigger event. Stored video patterns may include user selected video patterns (e.g., administrator selected video patterns). The service includes executing a recovery action associated with the trigger event. The recovery action may include notifying an administrator, creating an event log, or storing cached video data, as examples. Stored video patterns may include video patterns stored in response to previous trigger events.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12. Widget 12-n refers to the n-th widget of number n widgets. For example, if n is 6, widget 12-n refers to widget 12-6. Generally, widget 12-n indicates that the number of widgets in an example can vary.

Disclosed embodiments relate to monitoring and troubleshooting remote video devices. Remote video devices include Internet protocol (IP) based video assets such as Internet protocol television (IPTV) STBs. Disclosed systems can use expert, rules-based, pattern recognition methodologies from centralized and/or distributed locations and may perform: (1) acquiring and monitoring, in real time, different video streams from different remote locations; (2) building an adaptive, rule-based, pattern recognition and knowledge decision-tree framework; (3) cataloguing image patterns that represent known issues or defects that the system is monitoring and/or matching for; (4) triggering the appropriate action(s) when one or more rules in the knowledge decision-tree are matched; (5) archiving the video patterns into the knowledge base for future analysis; and (6) re-creating the events that trigger the alarms, to enhance the algorithms that provide corrective actions. These actions could include automatic recovery steps that are needed to fix the video assets and bring them back to predetermined, healthy states or notifying the operator (e.g., STB user) to take corrective actions, where applicable.

Disclosed systems enable users to automatically monitor and troubleshoot any remote video assets such as video-based applications, simulation tools, STBs, mobile phones, and personal-digital assistants (PDAs), over different IP-based networks such as local area networks (LANs), wide area networks (WANs), and cellular networks (e.g., 3G, 4G, etc.) that operate over any transport media (e.g., copper, fiber, fixed-wireless, cellular, coax, power line, etc).

Disclosed systems use a collection of predefined video patterns that are stored in a database (e.g., a video pattern database). The sequences of video patterns represent combinations of error and/or recovery conditions on the remote devices. When partial and/or complete matches of the video patterns occur, triggers are sent to an NOC of an MCDN to automatically analyze the display images provided by the remote video devices that appear to be problematic. Next, a sequence of specific video patterns from the database, based on the diagnosis of errors, is automatically compared against the video images from the remote device. From the video comparisons, the final status of the device can be derived and subsequent actions, if needed, can be taken. If no further actions are deemed necessary, the problematic device can be flagged as operating normally. With disclosed systems, remote video devices may be part of a continuous feedback loop. In this way, the remote video devices are continuously monitored and the video images provided by the remote video devices are compared against pre-determined video patterns to detect whether the remote video devices are operating normally.

Disclosed systems provide for (1) automated detection of abnormal conditions, via partial and/or complete matches of predefined video patterns, of remote device(s) and/or transport networks that are carrying video; (2) automated alert to the network control center of such problems; (3) objective and automated responses to diagnose current problems; (4) visual display of status of remote devices as they recover from abnormal conditions; and (5) a continuous feedback loop for system monitoring and troubleshooting of remote video resources and devices, via pattern recognition. Disclosed systems may be used, for example, by telecommunications carriers, mobile operators, cable operators, fixed wireless operators, government-sponsored and/or owned entities, power companies, etc. to monitor remote video devices. Disclosed systems may also be used by producers of hardware, software, and/or firmware that are involved in the design, delivery, maintenance, and testing of video-based applications and associated simulation tools. Disclosed systems may be deployed to monitor remote video devices which receive multimedia content from broadband networks operating, for example, through wire line, fixed-wireless, mobile, cable, power lines, and other such systems. Such examples are provided for illustration purposes only and are not intended to limit the scope of the appended claims.

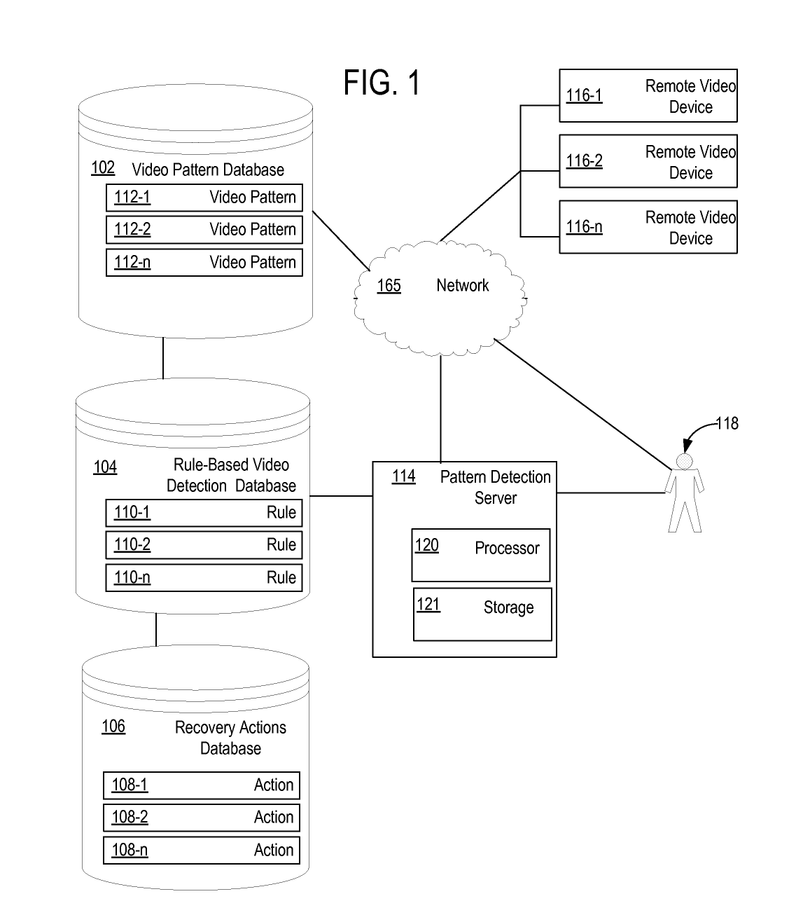

Referring now to the figures, FIG. 1 depicts a system for monitoring remote video devices 116. Network 165 can be part of an MCDN which may include an IPTV network. As shown, pattern detection server 114 is communicatively coupled to network 165. Remote video device 116-1 represents an STB located at a remote location such as a customer residence or business. Remote video devices 116 may be mobile devices or other such devices that receive video data from network 165.

In operation, pattern detection server 114 receives video pattern data from remote devices such as remote video device 116-2. The video pattern data represents video patterns presented at the remote location by remote video device 116-2. For example, the video pattern data may represent video patterns (e.g., images or screenshots) from a multimedia program presented by a remote video device such as an STB or a television that incorporates STB-like functionality. Pattern detection server 114 may convert the video pattern data received from the remote location to video patterns and compare the video patterns to predetermined video patterns (e.g., video pattern 112-2). As shown, video pattern database 102 includes video patterns 112. Video patterns 112 may be user selected (e.g., administrator selected) and may be adapted during operation of pattern detection server 114 to include additional video patterns. In addition, video patterns 112 may be modified automatically during remote video device monitoring.

If the device video pattern matches a predetermined video pattern (e.g., video pattern 112-1), pattern detection server 114 accesses a rule (e.g., rule 110-1) corresponding to the predetermined video pattern. As shown, rule-based video detection database 104 includes rules 110-1 through 110-n. Rules 110 may be modified by an administrator and may include decision tree information. As shown, recovery actions database 106 includes recovery actions 108. Recovery actions 108 represent actions executed in response to certain trigger events. Trigger events may be determined by rules 110. For example, rule 110-2 may dictate a trigger event upon a threshold number of occurrences of video pattern 112-2 occurring at a remote video device (e.g., remote video device 116-1). In response to the trigger event, execution of recovery action 108-2 may be initiated by pattern detection server 114. An example recovery action is a reboot of remote video device 116-2. As another example recovery action, remote video device 116-2 may be brought to a predetermined state such as one presenting an interface to a remote user for recording multimedia content. Other examples of recovery actions are e-mailing, phoning, or paging administrator 118 regarding the trigger event.

In an example scenario, rule 110-1 is associated with video pattern 112-1 such that if a device video pattern matches a video pattern 112-1, rule 110-1 directs a trigger event. Pattern detection server 114 monitors remote video device 116-1 and receives video pattern data from remote video device 116-1 over network 165. Pattern detection server 114 compares a device video pattern extracted from the received video pattern data. The device video pattern is compared to video patterns 112. Responsive to the device video pattern matching video pattern 112-1, pattern detection server 114 accesses rule 110-1 which is associated with predetermined video pattern 112-1. For a response to trigger events, rule 110-1 is associated with a recovery action (e.g., action 108-1). An example recovery action is notifying administrator 118 by text message, paging, telephone call, or e-mail regarding a trigger event. As shown, pattern detection server 114 is communicatively coupled to administrator 118. In addition, network 165 is communicatively coupled to administrator 118. Execution of a recovery action initiated by pattern detection server 114 may be performed by network 165, pattern detection server 114, or any subcomponents included in either. Recovery actions include contacting administrator 118, affecting the operation of remote video devices 116, or affecting the operation of subcomponents of network 165 to affect the video content received at remote video devices 116.

In some embodiments, remote video devices 116 are enabled for encoding video pattern data and transmission (e.g., streaming) of video pattern data through network 165 to pattern detection server 114. Transmitting the encoded video pattern data may include transmitting over an IP-based network. An example video pattern in video pattern database 102 is a crash screen. A crash screen may be any screen shot presented by remote video devices 116 that indicate an error in the operation of the remote video devices. For example, the crash screen may indicate that remote video device 116-1 has rebooted, cannot detect a hard drive, is not receiving a video signal, is receiving a weak signal, is not receiving an audio signal, is not receiving closed caption information, and the like. In response to pattern detection server 114 detecting that a crash screen has occurred at a remote video device, pattern detection server 114 may execute a recovery action such as obtaining a crash log (not depicted) from remote video device 116-1. The crash log may be an electronic file indicating the status of certain components within or related to remote video device 116-1 during a crash event.

As shown in FIG. 1, pattern detection server 114 includes processor 120 and storage 121. Storage 121 includes computer instructions for receiving video data forwarded from a remote location. During normal operation, the video data includes portions of a multimedia program received by a remote video device such as remote video device 116-1. Further instructions embedded in storage 121 enable pattern detection server 114 to compare a remote video pattern indicated by the received video data to stored video patterns (e.g., video patterns 112) to detect a video pattern event as determined by rules 110. In an example scenario, the video pattern event indicates an absence of normal operation by remote video device 116-1. The video pattern event may be determined by applying rule 110-1, which in an example embodiment results in a trigger event if a remote video pattern extracted from video data received from remote video device 116-1 corresponds to video pattern 112-1 and video pattern 112-2 more than a threshold number (e.g., five) of times. In this way, a trigger event may be related to multiple video patterns 112.

Accordingly, storage 121 includes instructions for extracting a rule (e.g., rule 110-1) from rule-based video detection database 104. In an example, rule 110-1 corresponds to a video pattern event that indicates remote video device 116-1 is receiving a video signal with electronic interference. Rule 110-1 may include decision tree information for determining when video data received from remote video device 116-1 indicates such a video pattern event. Further instructions embedded in storage 121 enable pattern detection server 114 to initiate a recovery action corresponding to the extracted rule. For example, the recovery action may be notifying administrator 118 by e-mail that remote video device 116-1 is receiving a video signal with electronic interference. As another example, the recovery action may be to reboot remote video device 116-1 or to present an on-screen instruction to the user of remote video device 116-1 to check for proper connection of any wires or cables connected to remote video device 116-1 or associated components.

The system shown in FIG. 1 may be used for providing an embodied service for detecting video patterns. In a particular embodiment, the service includes streaming encoded video information to a pattern detection engine. For example, the service may include enabling remote video device 116-1 to stream video data related to video images presented locally by remote video device 116-1. Remote video device 116-1 may retransmit all or portions of a multimedia program presented by remote video device 116-1. In an exemplary embodiment, the streamed video data is sent through network 165 to pattern detection server 114. In an alternative embodiment, the functionality of pattern detection server 114 may be implemented locally at remote video devices 116. Implementation of the functionality of pattern detection server 114 at remote video devices 116 may be within the remote video devices themselves or may be in a pattern detection device (not depicted) local to the remote video device. In this embodiment, the streamed video data is acquired by the pattern detection device directly, including through baseband video capture or video decoding of the video stream from remote video devices 116. The service may further include comparing a portion of the video information to stored video patterns (e.g., video patterns 112) and detecting a trigger event from the comparing. The trigger event may be determined by accessing rules 110 stored within rule-based video detection database 104. Rules 110 may apply decision tree information and compare video patterns received from a remote video device to video patterns 112. Video patterns 112 may include video patterns stored in response to previous trigger events. In response to a trigger event, the recovery action (e.g., recovery action 108-2) associated with the trigger event is executed by the service. The recovery action provided by the service may include notifying an administrator, such as by e-mailing or paging the administrator.

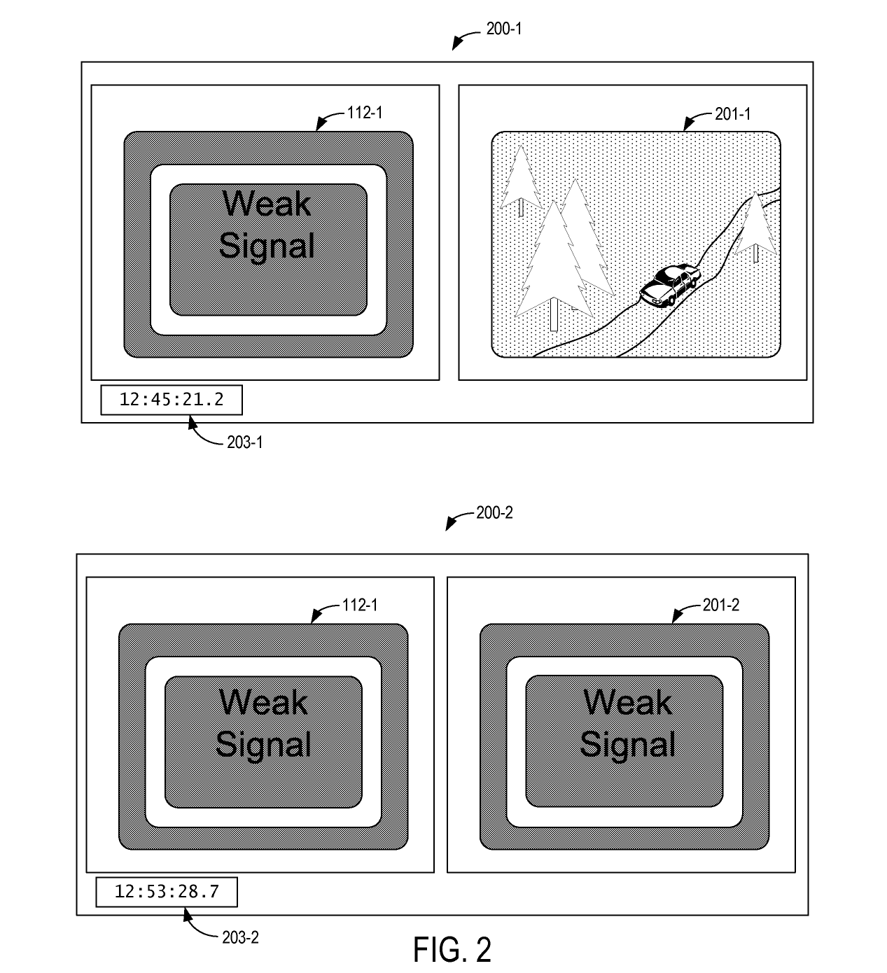

FIG. 2 illustrates an administrator interface 200-1 with video pattern 112-1 that indicates a “Weak Signal.” As shown in FIG. 2, video pattern 112-1 may be stored as video pattern 112-2 in FIG. 1 within video pattern database 102. Video pattern 112-1, as shown in FIG. 2, is an exemplary video pattern. Claimed embodiments do not necessarily operate using only video patterns 112 (e.g., in FIG. 1) that include text, for example.

As shown, interface 200-1 includes a video pattern 112-1 and a device video pattern 201-1. Device video pattern 201-1 includes video pattern data received from a remote video device (e.g., remote video device 116-1 in FIG. 1). Device video pattern 201-1 may include all video images provided by a remote video device or may include samples of video images (e.g., every fourth frame) provided to a remote video device. Information from timer 203-1 may be used to stamp video patterns with a timestamp. A pattern detection server (e.g., pattern detection server 114 in FIG. 1 or local pattern detection device not depicted) compares device video pattern 201-1 to video pattern 112-1, which may be a predetermined video pattern or a user selected video pattern. Interface 200-2 illustrates device video pattern 201-2 which looks identical to or similar to video pattern 112-1. If a rule (e.g., 110-1 in FIG. 1) declares that a trigger event corresponds to a match between video pattern 112-1 and device video pattern 201-1, then a trigger event occurs at time 203-2 as shown in interface 200-2. Data (e.g., video images) indicative of the trigger event may be stored. In addition, device video pattern 201-1 and other such data may be stored for later analysis. Interface 200-1 and 200-2 are shown to demonstrate when a device video pattern corresponds to a stored video pattern (e.g., a predetermined video pattern). Disclosed embodiments do not necessarily include an interface (e.g., interface 200-1) that displays video images, because disclosed systems may analyze video data without displaying the video images.

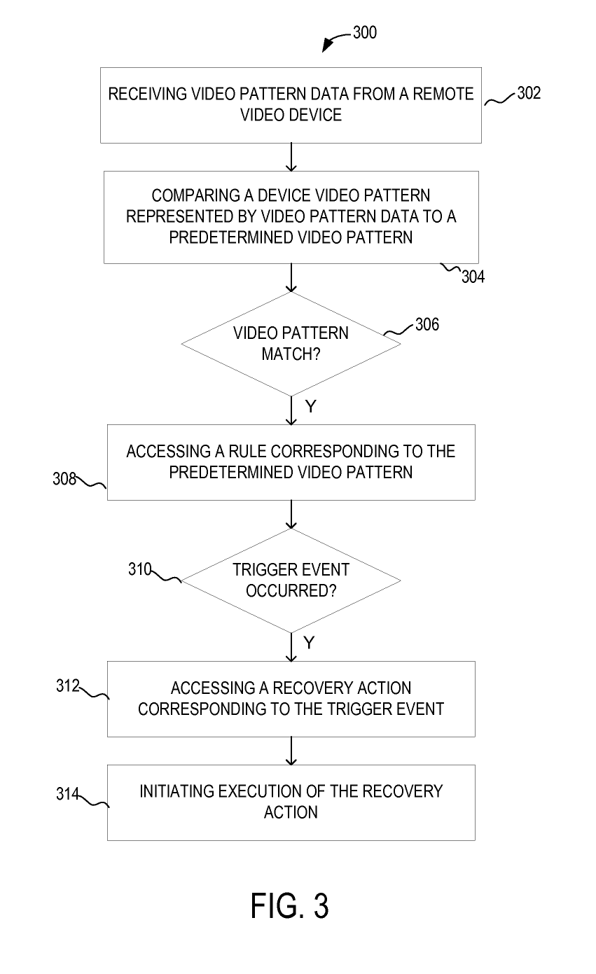

FIG. 3 illustrates a computer method 300 for monitoring a remote video device. As shown, the method includes receiving (block 302) video pattern data from a remote video device. A device video pattern represented by the video pattern data is compared (block 304) to a predetermined video pattern. If there is a video pattern match (block 306), a rule is accessed (block 308) that corresponds to the predetermined video pattern. In some embodiments, a determination is made (block 310) whether a trigger event has occurred. If a trigger event has occurred, a recovery action corresponding to the trigger event is accessed (block 312). The execution of the recovery action is initiated (block 314).

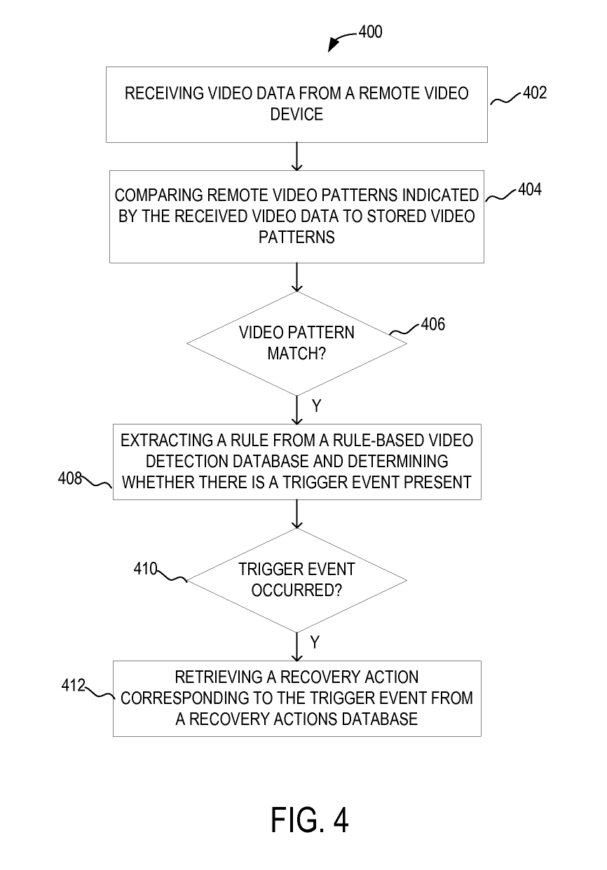

FIG. 4 illustrates functions of a computer program 400 provided by instructions for receiving (block 402) video data from a remote video device. During normal operation of a remote video device, the received video data includes portions of a multimedia program. Further instructions are for comparing (block 404) remote video patterns indicated by the received video data to stored video patterns. Comparing remote video patterns to stored video patterns is performed to detect a video pattern event that indicates an absence of the normal operation at the remote location. If there is a video pattern match (block 406), further instructions are for extracting (block 408) a rule from a rule-based video detection database. The rule corresponds to the video pattern event. Optional instructions are for determining (block 410) whether a trigger event has occurred. If a trigger event has occurred, further instructions retrieve (block 412) a recovery action corresponding to the trigger event from a recovery actions database.

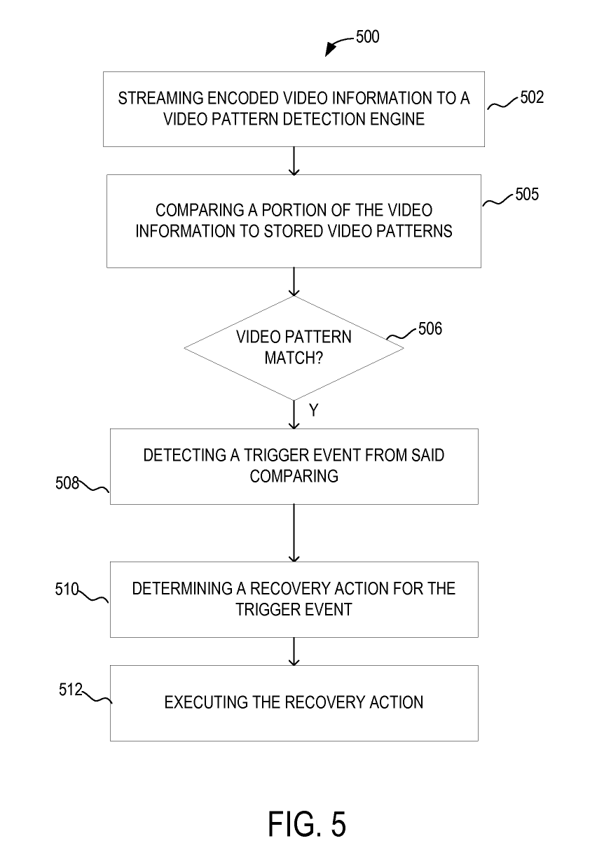

FIG. 5 illustrates aspects of an embodied service 500 for detecting video patterns. The service includes streaming (block 502) encoded video information to a video pattern detection engine. A portion of the video information is compared (block 505) to stored video patterns. If a video pattern match occurs (block 506), a trigger event may be detected (block 508). A recovery action for the trigger event is determined (block 510) and executed (block 512). In an exemplary embodiment, encoded video information is decoded at the video pattern detection engine for analysis and comparison purposes, including comparing the decoded video information (block 505) to stored video patterns.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A computer method of monitoring a remote video device, the method comprising:
receiving video pattern data from the remote video device;
comparing a device video pattern represented by video pattern data to a predetermined video pattern;
responsive to the device video pattern matching the predetermined video pattern, accessing a rule corresponding to the predetermined video pattern, wherein the rule indicates a recovery action; and
initiating execution of the recovery action.

2. The computer method of claim 1, wherein the recovery action includes notifying an administrator regarding the trigger event.

3. The computer method of claim 2, wherein notifying comprises one of e-mailing an administrator regarding the trigger event, telephoning an administrator regarding the trigger event, and paging an administrator regarding the trigger event.

4. The computer method of claim 1, further comprising:
updating a database of predetermined video patterns based on the device video pattern.

5. The computer method of claim 1, wherein the remote video device is a set-top box.

6. The computer method of claim 5, wherein said receiving comprises receiving via a multimedia content distribution network (MCDN).

7. The computer method of claim 6, wherein the MCDN comprises an Internet protocol television network.

8. The computer method of claim 1, further comprising:
encoding the video pattern data for transmission from the remote video device.

9. The computer method of claim 8, further comprising:
transmitting the encoded video pattern data via an Internet protocol based network.

10. The computer method of claim 1, wherein the predetermined video pattern represents a crash screen.

11. The computer method of claim 10, wherein the recovery action includes obtaining a crash log related to the crash screen.

12. A video pattern detection server comprising:
a processor; and
a storage including computer instructions, the computer instructions comprising instructions for:
receiving video data from a remote location, wherein during the normal operation the video data includes portions of a multimedia program;
comparing a remote video pattern indicated by the received video data to stored video patterns to detect a video pattern event, wherein the video pattern event indicates an absence of the normal operation at the remote location;
extracting a rule from a rule-based video detection database, wherein the rule corresponds to the video pattern event; and
based on the extracted rule, initiating a recovery action corresponding to the extracted rule.

13. The video pattern detection server of claim 12, wherein the video pattern detection server receives a video stream including the video data from a remote video device at the remote location, wherein the remote video device is enabled for encoding and streaming the video data.

14. The video pattern detection server of claim 12, wherein the rule-based video detection database includes decision tree information.

15. The video pattern detection server of claim 12, wherein the stored video patterns are adapted during operation based on received video data.

16. The video pattern detection server of claim 12, wherein the recovery action database includes information indicative of automatic recovery procedures for bringing a remote video device to a predetermined state.

17. The video pattern detection server of claim 12, wherein the video pattern detection server is enabled to re-create a trigger event associated with the remote video pattern, and further wherein the video pattern detection server is enabled for contacting an administrator regarding the trigger event.

18. A service for detecting video patterns, the service comprising:
streaming encoded video information to a video pattern detection engine;
comparing a portion of the video information to stored video patterns, detecting a trigger event from said comparing; and
executing a recovery action associated with the trigger event.

19. The service of claim 18, further comprising: decoding the encoded video information at the video patter detection engine.

20. The service of claim 18, wherein the stored video patterns include video patterns stored in response to previous trigger events, and further wherein the recovery action includes notifying an administrator.
